(19) United States
(12) Patent Application Publication
(10) Pub. No.: US 2010/0196118 A1
(43) Pub. Date: Aug. 5, 2010

(54) NUT FOR SELF-TAPPING SHEET METAL SCREWS

(76) Inventor: Chiang Heng Wong, Selangor (MY)

Correspondence Address: Brinks Hofer Gilson & Lione/Ann Arbor, 524 South Main Street, Suite 200, Ann Arbor, MI, 48104, US

(21) Appl. No.: 12/677,635

(22) PCT Filed: Sep. 3, 2008
(86) PCT No.: PCT/MY2008/000095

§ 371 Date: Mar. 11, 2010

(30) Foreign Application Priority Data
Nov. 15, 2007 (MY) PI20071999

(51) Int. Cl. F16B 37/00; B23P 11/00

(52) U.S. Cl. 411/259; 29/428

(57) ABSTRACT

A nut for use with self-tapping screws (3) utilized in sheet metal work which comprises an elongated hexagonal-shaped body (1) with a straight through centre core (4) and has a flanged rear end (7) that is beveled (9) at the edge of the bore to assist in seating and proper alignment.

### FIELD OF INVENTION

This invention relates to fasteners for sheet metal work, in particular it relates to a nut for sheet metal work screws.

### BACKGROUND OF THE INVENTION

Self-tapping screws are widely used in sheet metal work to fasten two pieces of metal together without the use of nuts. As its name literally implies, it works by piercing through the metal piece and at the same time taps out a female thread in the bored metal edges thus making it behave like a “nut” fastening the two metal sheets together.

However as with most self-tapping screws, regardless of its gauge, length or number of threads per unit length, it often fails to work properly when the metal sheets used are relatively thin. Under such circumstance, the problem of over-driving the self-tapping screw often occurs where this process of over tapping damages the threading in the metal edges, thus making the screw loose its grip on the metal sheets.

This can be dangerous, especially when the thin metal components are structural components. Furthermore, it can very easily be left undetected, when the self-tapping fasteners are used in large quantities and spread over a wide area of a structure.

Even if a faulty fastener is found and subsequently removed, it would leave a hole in the sheet metal and that has to be substituted with a conventional nut and bolt and the former fastener then is discarded.

There is a need for a simple, more efficient and effective means of fastening the metal sheets in sheet metal work ranging from low end use to more structural applications. It is the object of the present invention to overcome the abovesaid problem by providing for a simple nut that helps to fasten the two metal sheets together more effectively.

It is a further object of the present invention to provide for a nut that is both cheap and economical to use and obviate additional tools for installation.

### SUMMARY OF THE INVENTION

The present invention is a nut for use with a self-tapping screw utilized in sheet metal work which comprises an elongated hexagonal-shaped body, preferably made of aluminum, similar in shape and size to the hexagonal head of the self-tapping screw. The nut has a desired length that should not be less than the self-tapping screw threaded length, yet not longer than the self-tapping shank, in order to ensure that the screw thread is entirely embedded in the nut centre core, thus providing maximum grip when engaged. It has a straight and through centre core, with a bore diameter, not exceeding the diameter of the screw thread of the self-tapping screw, in order for it to fully receive the self-tapping screw, in such a way where the self-tapping screw will form a female thread lining in the nut's inner wall and thereby provides the tightening effect between the nut and the screw.

The rear end of the body is flanged to act as a washer, to enable a better grip onto the surface of the metal sheets. The edge of the bore at the flanged end is beveled to assist in seating and in ensuring proper alignment of the nut prior to driving. The head end of the nut has an open bore, to enable the user to see the screw tip in order to ensure that when fully engaged, the screw has penetrated the nut properly and to its full depth. The edges of the nut is chamfered all round to remove any sharpness. The body of the nut is hexagonal-shaped like the head of the screw so that both can easily accommodate the same power tool or any commercial socket wrench for easy and convenient installation.

### BRIEF DESCRIPTION OF THE DRAWINGS

Having thus described the invention in general terms, reference will now be made to the accompanying drawings, which are not necessarily drawn to scale, and wherein

FIG. 1 shows the present invention in orthographic projection with the front view on one side and the rear view on the other side with the plan view in the middle shown as a sectional view in order to illustrate the centre core.

FIG. 2 shows the application of the present invention on to a self tapping sheet metal screw to hold and fasten two pieces of sheet metal plate. There is a cut-a-way portion to illustrate the engagement between the screw and the nut.

FIG. 3 shows perspective views of the present invention both from the rear end and the head end.

### DESCRIPTION OF A PREFERRED EMBODIMENT

The features and other details of the method and apparatus of the invention will now be more particularly described with reference to the accompanying drawings and pointed out in the claims. The same numeral present in different figures represent the same item.

It will be understood that the particular embodiments of the invention are shown by way of illustration and not as a limitation of the invention. The principal features of this invention can be employed in various embodiments without departing from the scope of this invention.

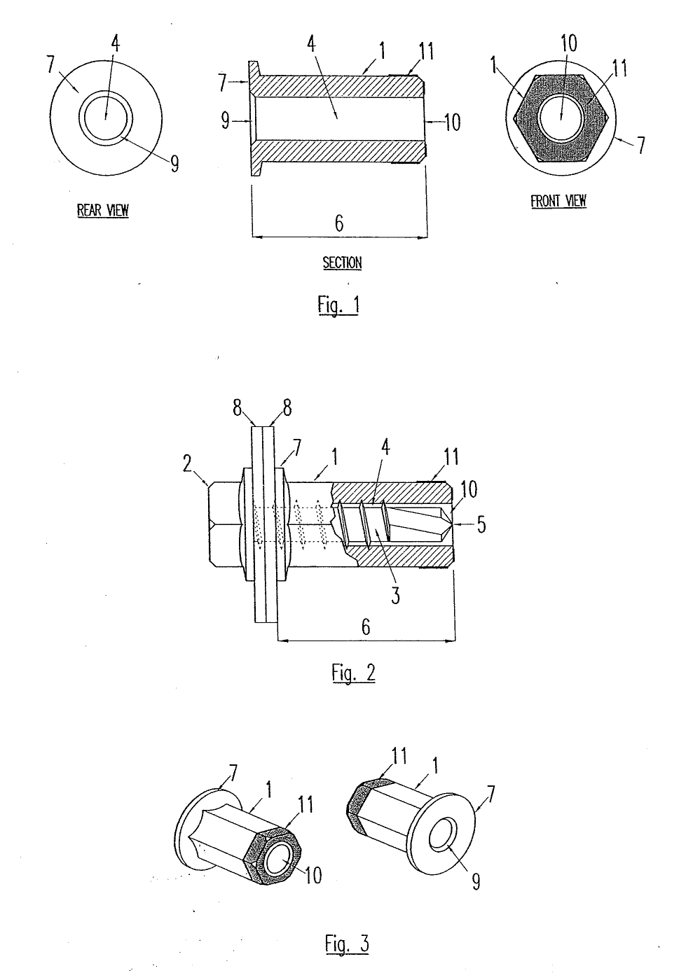

Referring to FIG. 1, the present invention is a nut shown in orthographic projection to comprise an elongated hexagonal-shaped body (1) preferably made of a light and soft metal like aluminum, with a shape and size equal to the hexagonal head (2) of the self-tapping screw (3) as illustrated in FIG. 2 which shows the application of a self-tapping screw (3) on to the present invention, in order that the same power tool or socket wrench may be used throughout, on both, to facilitate easy and convenient installation. It has a straight and through centre core (4) that runs the entire length of the body (1) with a bore diameter that depends on the gauge of the self-tapping screw (3) and should not exceed the diameter of the screw thread of the self-tapping screw (3) in order for it to receive the self-tapping screw (3), so that the self-tapping screw (3) will form a female thread lining in the nut's inner wall and thereby provides the tightening effect between the nut and the screw (3). The centre core (4) is right through from one end to the other so that the user can see the screw tip (5), which indicates that the screw (3) has penetrated the nut properly (not skewed) and fully.

The nut has a desired length which should not be less than the self-tapping screw (3) threaded length, yet not longer than the self tapping shank (6), in order to ensure that when the screw thread is entirely embedded in the nut centre core (4), it provides maximum grip when engaged. The nut has a flanged rear end (7) to be butted against the metal sheet (8) surface to give a better gripping power from the screw (3) and nut on the metal sheets (8) The bore at the flanged rear end (7) may be beveled (9) to assist in seating and proper alignment of the nut prior to driving. The head end of the nut (10) has an open bore so that the user can see the screw tip (5), to ensure that the screw (3) has penetrated the nut properly and to its full length and depth. The edges of the nut may be chamfered, if desired, to remove their sharp edges.

As the self-tapping screw (3) is driven into the nut as shown in FIG. 2, or vice versa (both methods applicable) the screw threads are tapped out as female lining on the inner core (4) wall of the nut. At the same time, the screw (3) also urges the walls of the inner core (4). Both of these processes provide a strong and tight fitting engagement between the self tapping screw (3) and the nut. The bore diameter is such that it is bigger than the diameter of the self-tapping screw (3) screw tip (5), so that during the driving process only the threading operation occurs and not the drilling. Thus the nut does not utilize the screw tip (5) ability of the self-tapping screw (3). The length of the nut is designed to fully utilize the self-tapping screw (3) thread. The more the thread can engage the stronger the fastening strength. The rear end of the nut (7) is flanged acting as a washer, providing additional grip between the nut and screw (3) onto the metal sheets (8). The rear end of the nut (7) has a beveled bore (9) to assist in receiving the self-tapping screw (3) in initial seating and proper alignment of the screw tip (5) into the nut, The head end (10) of the nut has an open bore, so that the user is able to see the screw tip (5). With that the user is able to know whether the self-tapping screw (3) had penetrated the nut correctly and to its full length and depth. The head end (10) of the body (1) of the nut should preferably be attached with a ferrous metal cap (11) to enable the nut to stick magnetically on to the power tool tip prior to driving during the installation process.

FIG. 3 shows the perspective view of the present invention viewed from the rear end (7) and from the head end (10).

The nut is made by extruding the metal or aluminum through an aperture of the desired size and shape of a hexagonal-shaped nut for a specific screw (3) size. The centre hollow core (4) may be made simultaneously in this extrusion process. The extruded piece is then cut to desired length depending on the specific screw shank (6) length. Next, the flanged end (7) can be shaped by automatic press with a mould forming the desired flange size and shape. The hollow ends (7) (10) may then be machine beveled (9) at the rear end (7) and chamfered at the head end (10) in the final process. The ferrous metal cap (11) can then be attached to the front end of the body (1). The nut can be coloured to indicate its various sizes.

A self-tapping screw (3) is initially driven through two metal sheets (8) using a power drive or wrench as in any normal process of fastening procedure using self-tapping screws (3) The protruded end of the self-tapping screw (3) may then be inserted with the nut. Fastening of the nut may be done using the same power drive, wrench or any hand tool whilst holding the screw head (2) with a similar tool appropriate for the purpose. Fastening of the nut may also be performed by driving the self-tapping screw (3) whilst holding the nut. Both methods are workable depending on the situation and the user's convenience.

Where over-driving of the screw (3) had occurred, the use of the present invention allows the self-tapping, screw (3) to be reused, thus avoiding unnecessary wastage. For the self-tapping screw (3) that is properly fastened, the application of the present invention provides a much more secure fastening, free from fear of any possibility of self-tapping screws (3) loosening through time.

The present invention has been described in detail. However it is to be understood that the detailed description and the specific examples, while indicating preferred embodiments of the invention, are given by way of illustration only, since.

various changes and modifications within the ambit and scope of the invention will become apparent to those skilled in the art from this detailed description.

1. A nut for use with a self-tapping screw utilized in sheet metal work which nut comprises:
an elongated hexagonal-shaped body with a straight and through centre core;
the shape and size of the elongated hexagonal-shaped body is complementary to a hexagonal head of a self-tapping screw that is to be coupled to the nut;
a length that equal to or greater than a thread length of the self-tapping screw, and equal to or less than a length of a self-tapping shank of the self-tapping screw so that the self-tapping screw can be fully received in the nut in such a way the self-tapping screw will form a female thread lining in an inner wall of the nut and thereby provide a tightening effect between the nut and the screw;
the centre core has a bore diameter equal to or less than a diameter of the screw thread of the self tapping screw, and greater than a diameter of a screw tip of the self-tapping screw, so that during a process in which the self-tapping screw is driven into the nut only threading of the nut occurs and drilling of the nut does not occur;
a flange rear end that functions as a washer and provides a grip; and
a beveled portion formed at the flanged rear end which assists in seating and proper alignment of the nut.

2. A nut as claimed in claim 1, wherein the nut is made of aluminum.

3. a nut as claimed in claim 1, wherein the nut it has a ferrous metal cap attached to a head end of the elongated hexagonal-shaped body.

4. (canceled)

5. A method of fastening a self-tapping screw used in sheet metal work which method comprises:
providing a self-tapping screw;
providing a nut that includes:
an elongated hexagonal-shaped body with a straight and through centre core that is complementary shaped to a hexagonal head of the self-tapping screw;
a length that is equal to or greater than a thread length of the self-tapping screw, and equal to or less that a length of a self-tapping shank of the self-tapping screw; and
the centre core has a bore diameter that is equal to or less than a diameter of the screw thread of the self-tapping screw, and equal to or less than a diameter of a screw tip of the self-tapping screw; and
driving the self-tapping screw into the nut so that threading of the nut occurs and drilling of the nut does not occur.

6. The method of fastening a self-tapping screw according to claim 5, further comprising providing a flange on a rear end of the nut which acts as a washer and enables a better grip

7. The method of fastening a self-tapping screw according to claim 6, further comprising providing a beveled portion at the flanged rear end of the nut to assist in seating and proper alignment of the nut.
